(19) United States
(12) Patent Application Publication
(10) Pub. No.: US 2009/0082472 A1
(43) Pub. Date: Mar. 26, 2009

(54) HAND SANITIZER AND METHOD OF PREPARATION

(76) Inventor: Marlin W. Peters, Locust Grove, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/027,378

(22) Filed: Feb. 7, 2008

Related U.S. Application Data
(60) Provisional application No. 60/995,207, filed on Sep. 25, 2007.

(51) Int. Cl. A01N 31/00; A01P 1/00

(52) U.S. Cl. 514/724

(57) ABSTRACT

A sanitizing composition or hand gel composition having a blend of SDA and Isopropyl Alcohol to kill germs and bacteria, a thickener, such as an acrylic polymer, a stabilizer or polymer acrylic acid neutralizer, such as polyoxyethylene (15) coconut alkylamine, octyl isononanoate as an emollient, glycerin as an additional moisturizer, water, and optionally fragrance or other additives.

### CROSS REFERENCE TO RELATED APPLICATIONS

The present application is based on and claims priority from U.S. Provisional Application Ser. No. 60/995,207, filed Sep. 25, 2007, which is hereby incorporated by reference.

### FIELD OF INVENTION

This invention relates generally to a formula for a hand sanitizing gel.

### BACKGROUND OF THE INVENTION

Hand sanitizing substances used as a disinfectant are intended to reduce the risk of exposure to and the spread of bacterial germs encountered in day-to-day activities.

Although the use of sanitizing hand gels is well known, a need exists for a formulation that will more effectively kill germs and dry quickly. However, many such quick drying gels have a composition that leaves an undesirable sticky residue. In addition, if the level of alcohol is increased, such conventional gels often dry the skin. Accordingly, the need persists for a higher percentage of alcohol without generating an undesirable residue or the drying of the skin.

### SUMMARY OF INVENTION

Various embodiments of this invention relate generally to an anti-bacterial formula for an instant hand sanitizing substance that effectively kills 99.9% of germs, while leaving the user's hands moist and smooth without any sticky residue.

An aspect of the invention is a water based, hand sanitizing composition, comprising, by weight, germicidal components of about 71% to about 76% of the total composition, the germicidal components being isopropyl alcohol and cosmetic grade specially denatured alcohol (SDA), and where the isopropyl alcohol comprises about 9% to about 13% of the composition. The composition further may comprise octyl isononanoate of about 1.0% to about 1.5% and glycerin of about 6.75% to about 7.00%. Water, preferably de-ionized water, may be used for making up the remainder. Optionally, fragrance may be added at about 0.0% to about 0.2%. The cosmetic grade denatured alcohol may be selected from the group SDA-23, SDA-40, and SDA 40B. As a further option, additives such as of vitamin E, aloe vera gel, or hydrofyzed wheat proteins, may be included.

The present invention includes a method for preparing a sanitizing gel, comprising the steps of combining cosmetic grade denatured alcohol and acrylates/C10-30 alkyl acrylate crosspolymer to form a base mixture, adding isopropyl alcohol and octyl isononanoate to the base mixture, adding ethoxylated (15) cocoa alkylamine to the mixture to stabilize the thickness of the mixture and to neutralize the pH of the acrylates/C10-30alkyl acrylate crosspolymer, adding water (preferably de-ionized), and adding glycerin to form the sanitizing gel. Consistently, this method can include the further steps of adding fragrance, or an additive selected from the group of vitamin E, aloe vera gel, or hydrolyzed wheat proteins. The cosmetic grade denatured alcohol may be selected from the group SDA-23, SDA-40, and SDA 40B.

Accordingly, it is a principal object of the invention to provide an anti-bacterial formula for a hand sanitizing substance, which is used in lieu of or in conjunction with traditional hand-washing. It is another object of the invention to provide a germicidal solution having broad-spectrum germicidal effect. It is a further object of the invention to provide a method of promoting hygiene. The above noted and other objects of the present invention will become readily apparent upon further review of the following specification and claims.

### DETAILED DESCRIPTION OF THE INVENTION

Although the use of sanitizing hand gels is well known, a need exists for a formulation with a higher percentage of alcohol that will effectively kill germs, dry quickly, leave no sticky residue, or excessively dry the skin. Most hand sanitizers with high alcohol content will excessively dry the skin. As a result, it is common to restrict the alcohol content in hand sanitizers to 62 percent or less. Decreasing the alcohol content has the unwanted effect of decreasing the composition's potency in killing germs and bacteria.

What has been needed is a composition for a sanitizer with a higher percentage of alcohol to be effective in killing germs, drying quickly, not leaving a sticky residue, and not excessively drying the skin, in various embodiments, the present invention is a composition and method of making a hand sanitizing composition that effectively kills germs and is gentle to the skin. Another unique feature of this formula is that it will not leave a sticky residue or feeling on the skin after use. This invention achieves all these functions with a single composition, including a method of preparing the composition.

One embodiment of the present invention has been shown to kill 99.9% of germs in seconds of application to common bacterial cultures. It is an alcohol based sanitizing composition intended for use in conjunction with or in place of traditionally used soap and water or germicidal towelettes such as described in U.S. Pat. No 5,753,246, which is hereby incorporated by reference.

Specifically in one embodiment the sanitizing composition is comprised of more than one kind of alcohol to kill germs and bacteria, a thickening agent, an acidic agent, a neutralizing agent to counter the acidic agent, an emollient and conditioner to moisturize and soften skin, stabilizing components, water, and optionally fragrance.

In one embodiment the sanitizing composition is comprised of a blend of cosmetic grade specially denatured alcohol and isopropyl alcohol, which are used to kill germs and bacteria, a thickener, such as an polymer acrylic acid, a stabilizer or polymer acrylic acid neutralizer, such as polyoxyethylene (15) coconut alkylamine, octyl isononanoate as an emollient, glycerin as an additional moisturizer, water, and optionally fragrance. For the purposes herein, “cosmetic grade” is intended to signify grades of denatured alcohol approved by governmental authorities, such as the U.S. Food & Drug Administration, for use in cosmetics. Among those denatured alcohols accepted within the U.S. as “cosmetic grade” are SDA-23, SDA-40, and SDA-40B.

Thus, a blended germicide component is used in the composition of various embodiments of the present invention. Most conventional hand sanitizers contain only one germ killing agent, typically isopropyl alcohol, which is poisonous, or commercial grade ethyl alcohol, which is harsh to the skin.

In various embodiments of the present invention, several germicidal agents may be effective, including a cosmetic grade denatured alcohol such as SDA 40B-190. In addition to cosmetic grade SDA, isopropyl alcohol may be added, which does not dry the skin as much as common ethyl alcohol. Other features of using isopropyl alcohol are its effectiveness as a cleaner, solvent, and disinfectant.

Thus, an aspect of the present invention is that more than one germicide is combined for an additive effect in killing germs and bacteria. The germicide components may be used in total (combined) amounts that range from about 71 to about 76 percent by weight of the sanitizing composition. Of this, isopropyl alcohol may be used in amounts which range from about 9 to about 13 percent by weight. The inventor has found that preferable compositions of the present invention using SDA 40B have shown a speed of drying that is approximately 50% faster than conventional hand sanitizers. It is believed that, without being bound to a particular theory, that cosmetic grade denatured alcohol dries very quickly, if not almost instantly, due to its typically high grade of purification and proof; SDA 40B also mixes well with the slower drying isopropyl alcohol. Together, the components form an effective, gentle, and rapidly drying germicide.

Another aspect and component is a skin moisturizer. A moisturizer may restore and operate to retain moisture in the skin. Several moisturizing agents are effective and can be used, including, for example, glycerin. The moisturizing component may be used in amounts which range from about 6 to about 7 percent by weight.

Another aspect and component is a thickener, such as an acrylic acid polymer. An effective thickener may be, for example, a cross-linked polyacrylic acid polymer that has been synthesized in a co-solvent ethyl acetate and cyclohexane mixture, forming acrylates/C10-30 alkyl acrylate crosspolymer. Such a thickener is generally available from Lubrizol Advanced Materials, Inc. under the name of Carbopol® ETD 2020. Examples of suitable hydrophilic thickeners nonexclusively include carbomers. This generally clear acrylic polymer thickens effectively with suspending capability and long viscous flow. It is designed to provide dispersions in water that are less susceptible to lumping and easier to pump and handle in processing due to its low dispersion viscosity before neutralization. Its dispersion performance allows it to wet quickly, yet hydrate slowly. This agent may be used in amounts which range from about 0.50 to about 0.60 percent by weight.

Optionally, other thickeners may be desirable, depending on the application. For example, acrylate copolymers, hydroxyethylcellulose modified with cetyl ether groups, polyvinylmethyl ether/maleic anhydride (PVM/MA) decadiene crosspolymer, and copolymers and mixtures thereof, with carbomers.

Another aspect and component is a stabilizer that stabilizes the thickness of the composition and neutralizes the polymer acrylic acid of the invention. Several stabilizing agents are effective and can be used, such as a polyethoxilated amine. Ethoxylated (15) cocoa alkylamine, or Ethomeen C25, is an example having surface-active properties and that may be used to neutralize the polymer acrylic acid. Ethomeen C-25 stabilizes or thickens a broad range of solvents, from less polar blends to nearly pure polar solvents, including mixtures. The stabilizing component may be used in amounts which range from about 0.30 to about 0.50 percent by weight.

Another aspect and component is an emollient and skin conditioner, such as but not limited to octyl isononanoate, also known under the name Dermol 89. This is an ester that may be made by a reaction of isononanoic acid with 2-ethylhexyl alcohol. This component is a moisturizer that helps to soften skin or to treat dry skin. Octyl isononanoate works by increasing the ability of the skin to hold water, providing the skin with a layer of oil to prevent water loss, and thus lubricating the skin. This component may be used in amounts that range from 1.00 to about 2.00 percent by weight.

Another aspect and component is water. Preferably, a type of purified water may be used, such as de-ionized water. De-ionized water is a common ingredient for hundreds of applications, including: medical, laboratory, pharmaceutical, cosmetics, electronics manufacturing, food procession, plating, and many industrial processes. The deionization process removes ions, such as, calcium, sodium, and chlorides. This component may be used in amounts in various embodiments, which range from about 18 to about 20 percent by weight.

Optional components may include fragrance, vitamins, proteins, etc. Fragrances may offer a smell of fruit, tea, flowers, or other fresh odor upon use of the skin sanitizer. Alternatively, the sanitizer may also be formulated without fragrance for individuals who do not desire or cannot tolerate fragrances. The fragrance, when added, is generally in amounts of about 0.15 to about 0.20 percent in weight. However, omission of a fragrance is preferable in some embodiments in that a fragrance may break down the gel. Optionally, vitamin E, aloe vera gel, hydrolyzed wheat proteins, or other additive may be mixed with the composition.

The following are three sample compositions in accordance with the present invention:

Composition No. 1

| Components | Weight Percent |
|---|---|
| SDA 40B 190 | 62.00 |
| Acrylates/C10-30 alkyl acrylate crosspolymer | 00.50 |
| Ethoxylated (15) Cocoa Alkylamine | 00.30 |
| Isopropyl Alcohol | 09.30 |
| Octyl Isononanoate | 01.00 |
| Glycerin | 06.75 |
| Deionized Water | 20.00 |
| Fragrance | 00.15 |
| TOTAL | 100% |

Composition No. 2

| Components | Weight Percent |
|---|---|
| SDA 40B 190 | 62.00 |
| Acrylates/C10-30 alkyl acrylate crosspolymer | 00.50 |
| Ethoxylated (15) Cocoa Alkylamine | 00.30 |
| Isopropyl Alcohol | 12.50 |
| Octyl Isononanoate | 01.00 |
| Glycerin | 06.75 |
| Deionized Water | 16.80 |
| Fragrance | 00.15 |
| TOTAL | 100% |

Composition No. 3

| Components | Weight Percent Range |
|---|---|
| SDA 40B 190 | 62.00-63.00 |
| Acrylates/C10-30 alkyl acrylate | 00.50-00.52 |
| crosspolymer | |
| Ethoxylated (15) Cocoa Alkylamine | 00.30-00.32 |
| Isopropyl Alcohol | 09.30-12.75 |
| Octyl Isononanoate | 01.00-01.50 |
| Glycerin | 06.75-07.00 |
| Deionized Water | remainder, typically 20.00-22.00 |
| Fragrance | 00.00-00.20 |
| TOTAL | 100% |

In one embodiment of the present invention and as seen in composition 1 above, the formula contains SDA 40B-190 at 62.00%, acrylates/C10-30 alkyl acrylate crosspolymer at 00.50%, ethoxylated (15) cocoa alkylamine 00.30%, isopropyl alcohol at 09.30%, octyl isononanoate at 01.00%, glycerin at 06.75% and the remainder de-ionized water at 20.00%, with optional fragrance at 00.15%.

In another embodiment of the present invention and as seen in composition 2 above, the formula contains SDA 40B-190 at 62.00%, acrylates/C10-30 alkyl acrylate crosspolymer at 00.50%, ethoxylated (15) cocoa alkylamine 00.30%, isopropyl alcohol at 12.50%, octyl isononanoate at 0.1.00%, glycerin at 06.75% and the remainder de-ionized water at 16.80%, with optional fragrance at 0.15%.

In another embodiment of the present invention and as seen in composition 3 above, the formula contains SDA 40B-190 at 62.00 -63.00%, acrylates/C10-30 alkyl acrylate crosspolymer at 00.50-00.52%, ethoxylated (15) cocoa alkylamine 00.30-00.32%, isopropyl alcohol at 09.30-12.75-%, octyl isononanoate at 01.00-01.50%, glycerin at 06.75-07.00% and the remainder de-ionized water, typically at 20.00-22.00%, with optional fragrance at 00.00-00.20%.

In one embodiment of the present invention the formula first combines the SDA and acrylates/C10-30 alkyl acrylate crosspolymer together creating a base mixture. The isopropyl alcohol and octyl isononanoate are then added together to the base mixture. Ethoxylated (15) cocoa alkylamine is added next, followed by the slow addition of the de-ionized water. As a final step, glycerin and optionally fragrance are added.

The advantage of this method is to create a slow and precise blending process of the ingredients. First, the SDA Alcohol and acrylates/C10-30 alkyl acrylate crosspolymer have to be mixed together because it takes longer for these two ingredients to blend. Then the other ingredients are individually added.

In one embodiment of the present invention, it only takes 2-3 drops to effectively disinfect the hands both front, and back. In one embodiment of the present invention the formula dries instantly, does not leave the hands feeling tight, sticky or excessively dry.

The composition may be applied to the hands or skin generally in a variety of forms, such as a liquid, cream, aerosol, and gel positioned with a variety of containers. It is envisioned that the various embodiments of the present invention can be packaged in various ways such as but not limited to plastic pump bottles, aerosol containers, and squirt bottles of varying size, disposable towelettes, whether individually packaged or packaged in bulk, touch-free dispensers, or combinations thereof.

This invention has been described in detail with particular references to certain embodiments. The above examples and embodiments should be considered to be illustrative and in no way limiting of the present invention. Thus, while the description above refers to particular examples, and embodiments, it will be understood that many modifications may be made without departing from the spirit thereof.

What is claimed is:

1. A water based hand sanitizing composition, by weight consisting essentially of:
germicidal components of about 71% to about 76% of the composition, the germicidal components comprising isopropyl alcohol and cosmetic grade denatured alcohol, wherein the isopropyl alcohol comprises about 9% to about 13% of the composition;
octyl isononanoate of about 1% to about 1.5%;
glycerin of about 6.75% to about 7%;
acrylates/C10-30 alkyl acrylate crosspolymer of about 0.50% to about 0.52%;
ethoxylated (15) cocoa alkylamine of about 0.30% to about 0.32%;
fragrance from about 0.0% to about 0.2%; and
the remainder water.

2. The composition of claim 1, wherein the cosmetic grade denatured alcohol is selected from the group SDA-23, SDA-40, and SDA 40B.

3. The composition of claim 1, further consisting essentially of an additive selected from the group of vitamin E, aloe vera gel, or hydrolyzed wheat proteins.

4. A hand sanitizing composition, comprising, by weight:
(a) from about 62% to about 63% cosmetic grade denatured alcohol;
(b) from about 0.50% to about 0.52% acrylates/C10-30 alkyl acrylate crosspolymer;
(c) from about 0.30% to about 0.32% ethoxylated (15) cocoa alkylamine;
(d) from about 9.30% to about 12.75% isopropyl alcohol;
(e) from about 1.0% to about 1.5% octyl isononanoate;
(f) from about 6.75% to about 7.00% glycerin; and
(g) from about 0.0% to about 0.2% fragrance; and
(h) the remainder water.

5. The composition of claim 4, wherein the water is de-ionized.

6. The composition of claim 4, wherein the cosmetic grade denatured alcohol is selected from the group SDA-23, SDA-40, and SDA 40B.

7. The composition of claim 4, further comprising an additive selected from the group of vitamin E, aloe vera gel, or hydrolyzed wheat proteins.

8. A hand sanitizing composition, comprising, by weight:
(a) about 62% cosmetic grade denatured alcohol;
(b) about 0.5% thickener;
(c) about 0.3% ethoxylated (15) cocoa alkylamine;
(d) about 9.3% isopropyl alcohol;
(e) about 1.0% octyl isononanoate;
(f) about 6.75% glycerin;
(g) about 0.15% fragrance; and
(h) the remainder water.

9. The composition of claim 8, wherein the water is de-ionized.

10. The composition of claim 8, wherein the cosmetic grade denatured alcohol is selected from the group SDA-23, SDA-40, and SDA 40B.

11. The composition of claim 8, further comprising an additive selected from the group of vitamin E, aloe vera gel, or hydrolyzed wheat proteins.

12. A hand sanitizing composition, comprising, by weight:
(a) about 62% cosmetic grade denatured alcohol;
(b) about 0.5% thickener;
(c) about 0.3% ethoxylated (15) cocoa alkylamine;
(d) about 1.2.5% isopropyl alcohol;
(e) about 1% octyl isononanoate;
(f) about 6.75% glycerin;
(g) about 0.15% fragrance; and
(h) the remainder water.

13. The composition of claim 12, wherein the water is de-ionized.

14. The composition of claim 12, wherein the cosmetic grade denatured alcohol is selected from the group SDA-23, SDA-40, and SDA 40B.

15. The composition of claim 12, further comprising an additive selected from the group of vitamin E, aloe vera gel, or hydrolyzed wheat proteins.

16. A method for preparing a sanitizing gel, comprising the steps of:
(a) combining cosmetic grade denatured alcohol and acrylates/C10-30 alkyl acrylate crosspolymer to form a base mixture;
(c) adding isopropyl alcohol and octyl isononanoate to the base mixture;
(d) then adding ethoxylated (15) cocoa alkylamine to the mixture to stabilize the thickness of the mixture and to neutralize the pH of the acrylates/C10-30 alkyl acrylate crosspolymer;
(e) adding de-ionized water; and
(f) adding glycerin to form the sanitizing gel.

17. The method of claim 16, further comprising the step of adding a fragrance to the mixture.

18. The method of claim 16, wherein the cosmetic grade denatured alcohol is selected from the group SDA-23, SDA-40, and SDA 40B.

19. The method of claim 16, further comprising the step of adding an additive selected from the group of vitamin E, aloe vera gel, or hydrolyzed wheat proteins.
